(19) United States
(12) Patent Application Publication
(10) Pub. No.: US 2005/0032948 A1
(43) Pub. Date: Feb. 10, 2005

(54) Ethylene terpolymer waxes, their preparation and their use

(76) Inventors: Andreas Fechtenkotter, Ludwigshafen (DE); Katrin Zeitz, Ludwigshafen (DE); Michael Ehle, Ludwigshafen (DE); Andreas Deckers, Flomborn (DE); Stefan Becker, Mannheim (DE)

Correspondence Address: KEIL & WEINKAUF, 1350 CONNECTICUT AVENUE, N.W., WASHINGTON, DC, 20036, US

(21) Appl. No.: 10/924,053

(22) Filed: Aug. 24, 2004

Related U.S. Application Data
(62) Division of application No. 10/435,456, filed on May 12, 2003.

(30) Foreign Application Priority Data
May 15, 2002 (DE) 10221804.8

(51) Int. Cl. C08L 1/00

(52) U.S. Cl. 524/235

(57) ABSTRACT

An ethylene terpolymer wax comprising, as monomer building blocks, from 35 to 95% by weight of ethylene,
from 0.1 to 40% by weight of at least one ester of the formula I 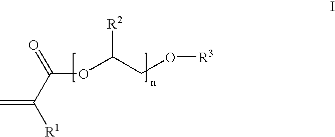
where R¹ is selected from hydrogen, C₁-C₁₀-alkyl, C₃-C₁₂-cycloalkyl and C₆-C₁₄-aryl
R² are identical or different and are selected from hydrogen and C₁-C₁₀-alkyl,
R³ is selected from C₁-C₁₀-alkyl, C₃-C₁₂-cycloalkyl and C₆-C₁₄-aryl and n is an integer from 2 to 100,
   and from 0.1 to 25% by weight of at least one carboxylic acid of the formula II 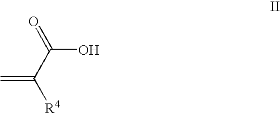
   where R⁴ is selected from hydrogen, C₁-C₁₀-alkyl, C₃-C₁₂-cycloalkyl and C₆-C₁₄-aryl.

The present invention relates to ethylene terpolymer waxes comprising, as monomer building blocks,
from 35 to 95% by weight of ethylene,
from 0.1 to 40% by weight of at least one ester of the formula I 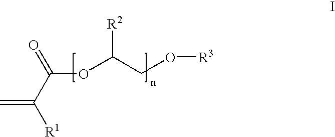
   where R¹ is selected from hydrogen, C₁-C₁₀-alkyl, C₃-C₁₂-cycloalkyl and C₆-C₁₄-aryl
R² are identical or different and are selected from hydrogen and C₁-C₁₀-alkyl,
R³ is selected from C₁-C₁₀-alkyl, C₃-C₁₂-cycloalkyl and C₆-C₁₄-aryl and
n is an integer from 2 to 100,
   and from 0.1 to 25% by weight of at least one carboxylic acid of the formula II 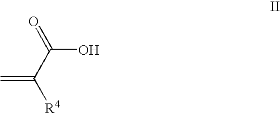
   where R⁴ is selected from hydrogen, C₁-C₁₀-alkyl, C₃-C₁₂-cycloalkyl and C₆-C₁₄-aryl.

Dispersible, especially emulsifiable waxes based on ethylene copolymers and ethylene terpolymers have a wide range of applications, for example as components in floor care compositions. Further possible uses are as hotmelt adhesives for metals, ceramic, wood, glass, leather or plastics, and furthermore adhesion promoters for coatings comprising polyolefins or rubbers or additives for coating materials. Not least, the economic importance of ethylene copolymers and ethylene terpolymers is attributable to the favorable price.

As a rule, floor care compositions, for example wax floor polishes, have to meet high requirements. In addition to a favorable price, they should have a long shelf life and should also be easy to apply. The floors should have an attractive gloss and they should be capable of being walked on safely for a very long time. As a rule, attempts are made to establish these properties through the emulsifiable ethylene polymer used, which is employed as a component in the floor care composition.

The industrially known emulsifiable ethylene polymers are oxygen-containing ethylene polymers in which the oxygen can be introduced in various ways. A known two-stage process comprises the preparation of oxygen-free polyethylene waxes by free radical or Ziegler-Natta polymerization of ethylene, followed by the oxidation of the resulting polyethylene waxes by air or peroxides or pure oxygen or mixtures thereof, to give oxidate waxes. However, this last-mentioned process has technical disadvantages.

The oxidation of a polyethylene results in a reduction in the molecular weight of the parent polyethylene chains, which is disadvantageous for the hardness of the product. Moreover, the preparation of oxidate waxes is always a two-stage process, which requires additional investment (cf. for example: Ullmann's Encyclopedia of Industrial Chemistry, 5th edition, key words: Waxes, Vol. A 28, page 146 et seq., Verlag Chemie Weinheim, Basle, Cambridge, New York, Tokyo, 1996).

DE-A 100 08 931 discloses copolymers of from 90 to 95% by weight of ethylene, from 4 to 10% by weight of one or more
C₃-C₁₂-alkenecarboxylic acids and from 0 to 1.2% by weight of one or more tertiary esters of the corresponding
C₃-C₁₂-alkenecarboxylic acids, the waxes having a kinematic melt viscosity of from 800 to 3 000 mm2/s, measured at 120° C. They are obtained by polymerization of ethylene with one or more tertiary esters of C₃-C₁₂-alkenecarboxylic acids under high-pressure conditions, the temperature varying by less than 5° C. in the course of the polymerization. However, the properties of the floor care compositions which can be prepared from the copolymers described can be further improved.

EP 0 224 029 describes high molecular weight elastomeric copolymers of ethylene with polyalkylene glycol (meth)acrylates, which comprise from 30 to 80 parts by weight of ethylene, from 2 to 40 parts by weight of (meth)acrylates and from 0 to 40 parts by weight of an α,β-unsaturated carboxylic acid, of a carboxylic anhydride or of a carboxamide and have melt flow indices of less than 1 000 g/10 min, measured according to DIN 53735 at 190° C. and 2.16 kp load. They have elastomeric properties and are stable to ozone. They are water-dispersible and are very suitable as components for adhesives but are unsuitable as components in floor care compositions.

It is an object of the present invention
to provide novel ethylene terpolymers,
to provide a process for the preparation of the novel ethylene terpolymers, and in particular
to provide novel floor care compositions which have improved properties compared with the prior art.

We have found that this object is achieved by the ethylene terpolymers defined at the outset.

The novel ethylene terpolymers are waxy terpolymers of ethylene and at least 2 comonomers, the waxes usually having a melt viscosity of from 20 to 70 000, preferably from 300 to 55 000, mm2/s, measured at 120° C. according to DIN 51562. Their acid number is from 1 to 150, preferably from 5 to 100, in particular up to 80, mg KOH/g wax, determined according to DIN 53402. The melting points are from 60 to 110° C., preferably from 80 to 109° C., determined by DSC according to DIN 51007. The density is usually from 0.89 to 0.99, preferably from 0.92 to 0.96, g/cm³, determined according to DIN 53479.

According to the invention, the novel ethylene terpolymer waxes used are composed of the following monomer building blocks:
from 35 to 95, preferably from 40 to 90, % by weight of ethylene,
from 0.1 to 40% by weight of at least one ester of the formula I 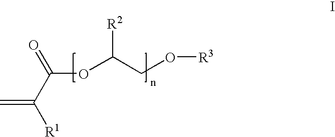
   where R¹ is selected from hydrogen, C₁-C₁₀-alkyl, C₃-C₁₂-cycloalkyl and C₆-C₁₄-aryl
R² are identical or different and are selected from hydrogen and C₁-C₁₀-alkyl,
R³ is selected from C₁-C₁₀-alkyl, C₃-C₁₂-cycloalkyl and C₆-C₁₄-aryl and
n is an integer from 2 to 100, preferably from 10 to 50,
   and from 0.1 to 25, preferably up to 20, % by weight of at least one carboxylic acid of the formula II 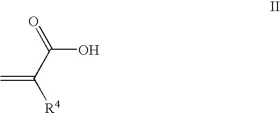
   where R⁴ is selected from hydrogen, C₁-C₁₀-alkyl, C₃-C₁₂-cycloalkyl and C₆-C₁₄-aryl.

In formula I, R¹ and R³, independently of one another, are selected from
hydrogen,
C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl; and R² are in each case identical or different and are selected from
C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; preferably C₁-C₄-alkyl, such as methyl, ethyl, n-propyl, isopropyl, n-butyl, isobutyl, sec-butyl and tert-butyl, in particular methyl or ethyl;
or hydrogen.

Very particularly preferably, R¹ and R³ are selected from hydrogen and methyl, and R² is very particularly preferably hydrogen, methyl or ethyl.

At higher values of n, in many cases individual esters of the formula I cannot be prepared in pure form. They are obtained as mixtures. In the context of the present invention, n is therefore to be understood as meaning the number average for values of n>10, in particular n>15.

Carboxylic acids are to be understood as meaning unsaturated carboxylic acids of the formula II, where R⁴ in formula II is selected from
hydrogen,
C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, n-nonyl and n-decyl; particularly preferably C₁-C₄-alkyl, such as methyl, ethyl, n-propyl, isopropyl, n-butyl, isobutyl, sec-butyl and tert-butyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Acrylic acid and methacrylic acid are preferred. Methacrylic acid is very particularly preferred.

In the novel ethylene terpolymers, R¹ and R⁴ are in each case preferably identical.

The monomer building blocks are preferably randomly distributed in the novel polymers.

In a preferred embodiment of the present invention, the novel ethylene terpolymer waxes comprise two or more carboxylic acids of the formula II as monomer building blocks, for example in molar ratios of from 1:10 to 10:1, preferably from 1:3 to 3:1. Very particularly preferably, the novel ethylene terpolymer waxes comprise acrylic acid and methacrylic acid as monomer building blocks. Such novel polymers are ethylene quaterpolymer waxes but, in the context of the present invention, are also included among the novel ethylene terpolymer waxes.

The present invention furthermore relates to a process for the preparation of the novel ethylene terpolymer waxes.

The preparation of the novel ethylene terpolymer waxes can be carried out in stirred high-pressure autoclaves or in high-pressure tubular reactors. The preparation in stirred high-pressure autoclaves is preferred. The stirred high-pressure autoclaves used for the novel process are known per se and are described in Ullmann's Encyclopedia of Industrial Chemistry, 5th edition, key words: Waxes, Vol. A 28, page 146 et seq., Verlag Chemie Weinheim, Basle, Cambridge, New York, Tokyo, 1996. They predominantly have a length/diameter ratio of from 5:1 to 30:1, preferably from 10:1 to 20:1. The high-pressure tubular reactors which can likewise be used are also described in Ullmann's Encyclopedia of Industrial Chemistry, 5th edition, key words: Waxes, Vol. A 28, page 146 et seq., Verlag Chemie Weinheim, Basle, Cambridge, New York, Tokyo, 1996.

Suitable pressure conditions for the polymerization are from 500 to 4 000, preferably from 1 500 to 2 500, bar. The reaction temperatures are from 170 to 300° C., preferably from 200 to 280° C.

The novel process can be carried out in the presence of a regulator. The regulator used is, for example, hydrogen or an aliphatic aldehyde or an aliphatic ketone of the formula IV 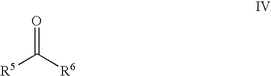
or a mixture thereof.

Here, R⁵ and R⁶ are identical or different and are selected from
hydrogen;
C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl and sec-hexyl, particularly preferably C₁-C₄-alkyl, such as methyl, ethyl, n-propyl, isopropyl, n-butyl, isobutyl, sec-butyl and tert-butyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl and cycloheptyl.

In a particular embodiment, R⁵ and R⁶ are covalently bonded to one another with formation of a 4- to 13-membered ring. Thus R⁵ and R⁶ together may be, for example, —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

The use of propionaldehyde (R⁵═H, R⁶═C₂H₅) or ethyl methyl ketone (R⁵═CH₃, R⁶═C₂H₅) as a regulator is very particularly preferred.

Further very suitable regulators are alkyl aromatic compounds, for example toluene, ethylbenzene or one or more isomers of xylene.

Further suitable regulators are straight-chain aliphatic hydrocarbons, for example propane. Particularly good regulators are branched aliphatic hydrocarbons having tertiary hydrogen atoms, for example isobutane, isopentane, isooctane or isododecane (2,2,4,6,6-pentamethylheptane). Isododecane is very particularly suitable. Higher olefins, for example propylene, may be used as additional regulators.

The amount of regulator used corresponds to the amounts customary for the high-pressure polymerization process.

Initiators which may be used for free radical polymerization are the conventional free radical initiators, for example organic peroxides, oxygen or azo compounds. Mixtures of a plurality of free radical initiators are also suitable.

Free radical initiators used are one or more peroxides selected from the commercially available substances
didecanoyl peroxide, 2,5-dimethyl-2,5-di(2-ethylhexanoyl-peroxy)hexane, tert-amyl peroxy-2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbo)cyclohexane as an isomer mixture, tert-butyl perisononanoate, 1,1-di(tert-butyl-peroxy)3,3,5-trimethylcyclohexane, 1,1-di(tert-butylperoxy)-cyclohexane, methyl isobutyl ketone peroxide, tert-butyl peroxyisopropylcarbonate, 2,2-ditert-butylperoxybutane or tert-butyl peroxyacetate;
tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropyl monohydroperoxide, cumyl hydroperoxide or tert-butyl hydroperoxide; or
dimeric or trimeric ketone peroxides of the formulae V a to V c.

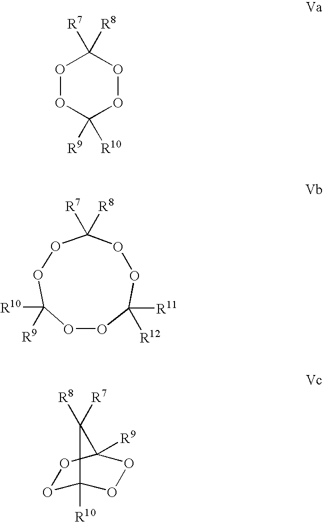

Here, R⁷ to R¹² are identical or different and are selected from
C₁-C₈-alkyl, such as methyl, ethyl, n-propyl, isopropyl, n-butyl, sec-butyl, isobutyl, tert-butyl, n-pentyl, sec-pentyl, isopentyl, n-hexyl, n-heptyl and n-octyl; preferably linear C₁-C₆-alkyl, such as methyl, ethyl, n-propyl, n-butyl, n-pentyl, and n-hexyl particularly preferably linear C₁-C₄-alkyl, such as methyl, ethyl, n-propyl and n-butyl, very particularly preferably ethyl;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably-phenyl.

Peroxides of the formulae V a to V c and processes for their preparation are disclosed in EP-A 0 813 550.

Particularly suitable peroxides are di-tert-butyl peroxide, tert-butyl peroxypivalate, tert-butyl peroxyisononanoate and dibenzyl peroxide and mixtures thereof. An example of an azo compound is azobisisobutyronitrile (AIBN). The free radical initiators are metered in amounts customary for polymerizations.

Monomers used are ethylene, at least one ester of the formula I and at least one carboxylic acid of the formula II. Esters of the formula I are prepared by subjecting a carboxylic acid of the formula VI and an alcohol of the formula VII 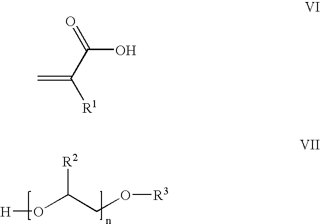
to esterification or transesterification reactions known per se.

Mixtures of I and VI obtained in the esterification can preferably be used as a comonomer mixture in the novel process.

The novel process is preferably carried out in the presence of solvents, where mineral oils and other solvents which are present in small amounts in the novel process and, for example, were used for desensitizing the free radical initiator or initiators are considered to be solvents for the novel process in the context of the present invention. Further solvents are, for example, the present invention. Further solvents are, for example, aromatic solvents, which are used as solvents in the preparation of esters of the formula I and were not completely removed after the end of the esterification or transesterification. Particularly preferred aromatic hydrocarbons are toluene, xylene isomers and ethylbenzene.

The monomers are usually metered together or separately. The ratio during the metering usually does not correspond exactly to the ratio of the monomer building blocks in the novel ethylene terpolymer waxes because esters of the formula I and carboxylic acids of the formula II are more easily incorporated into the novel ethylene terpolymer waxes than ethylene.

The metering of the monomer or monomers can be effected together with or separately from free radical initiator and any regulators used. It is also possible first to precompress the regulator or regulators to an intermediate pressure, i.e. from 180 to 300 bar, and then to meter them into the high-pressure autoclave or the high-pressure tubular reactor. The free radical initiator or initiators is or are preferably metered without precompression into the high-pressure autoclave or the high-pressure tubular reactor.

The novel ethylene terpolymer waxes can be excellently dispersed; in particular, they can be particularly readily emulsified in the molten state. The present invention therefore relates to dispersions, in particular aqueous dispersions, comprising the novel ethylene terpolymer waxes.

The novel dispersions preferably comprise from 1 to 40% by weight of one or more novel ethylene terpolymer waxes, from 60 to 98% by weight of water, one or more basic substances, for example hydroxides and/or carbonates of alkali metals, ammonia, organic amines, for example triethylamine, diethylamine, ethylamine, trimethylamine, dimethylamine, methylamine, ethanolamine, diethanolamine, triethanolamine, methyldiethanolamine or n-butyldiethanolamine, and, if required, further components, for example ethylene glycol, diethylene glycol or further dispersants.

The novel dispersions usually have a basic pH, preferably a pH of from 7.5 to 14, particularly preferably 8 or higher, very particularly preferably 9 or higher.

The present invention furthermore relates to the use of the novel ethylene terpolymer waxes or of the novel dispersions as floor care compositions or as components in floor care compositions.

The ability of the novel dispersions to form colorless, clear, glossy films can be utilized in floor care compositions. The nonslip properties and the suitability of floors for walking on can be improved by said floor care compositions.

A typical novel floor care composition comprises
from 10 to 20 parts by weight of the novel dispersions, which impart resilience, dirt-repellent behavior and gloss to the floor to be cared for,
from 0.5 to 5, preferably from 2 to 3, parts by weight of diethylene glycol,
from 0.1 to 10, preferably from 1 to 2, parts by weight of ethylene glycol,
from 0.1 to 10, preferably from 1 to 2, parts by weight of a permanent plasticizer, examples of plasticizers used being trialkyl phosphates, particularly preferably tri-(n-butoxy-ethyl) phosphate,
from 0.1 to 5, preferably from 0.5 to 1.5, parts by weight of a wetting and leveling agent, examples of wetting and leveling agents used being fluorinated surfactants, for example FC-129 from 3M,
from 20 to 30 parts by weight of a dispersion of polystyrene/acrylate as carrier material. A preferred example is Poligen® MF750.

The novel floor care composition is prepared by mixing the components, for example in a bucket, stirring together for 5 minutes generally being sufficient.

The present invention furthermore relates to the use of the novel ethylene terpolymer waxes as components in leather assistants, and to leather assistants comprising the novel ethylene terpolymer waxes. Leather assistants are to be understood as meaning in particular the emulsifiable fatliquoring agents. The novel emulsifiable fatliquoring agents comprise, as active components,
natural, modified or synthetic fats,
if required, further cationic components, for example ammonium salts,
if required, further emulsifiers
   and also water.

The novel leather assistants have excellent stability and little tendency to form fatty spews. If the novel leather assistants are used by methods known per se for fatliquoring leather, leather having a pleasantly fatty handle is obtained. Moreover, it is found that the use of the novel leather assistants in leather production makes the leather soft, increases its body and leads to an increase in the protective effect against moisture, dirt and undesired chemical influences.

The present invention furthermore relates to the use of the novel ethylene terpolymer waxes as components of construction chemicals, and to construction chemicals comprising the novel ethylene terpolymer waxes. Examples of construction chemicals are concrete plasticizers. Further construction chemicals in the context of the present invention are formwork oils, i.e. oils which are used to coat formworks into which, for example, concrete is subsequently poured.

The novel ethylene terpolymer waxes can furthermore be used, for example, as emulsifiers or emulsion improvers, for coating agrochemicals, such as fertilizers, as thixotropic agents, as MDFI in fuel oils and as dulling agents.

The present invention furthermore relates to the use of the novel ethylene terpolymer waxes as dispersants for dispersing hydrophobic substances in aqueous media. Hydrophobic substances are understood as meaning substances having a solubility of up to 0.5 g/l of water under standard conditions.

The invention is illustrated by working examples.

### WORKING EXAMPLES

1. Preparation of Novel Ethylene Terpolymer Waxes

Ethylene, polyethylene glycol methacrylate methyl ether (R¹═R³═CH₃; R²═H, n=21) and methacrylic acid (R⁴═CH₃) were polymerized with addition of toluene as solvent and a 50% by weight solution of propionaldehyde in isododecane as a regulator in a high-pressure autoclave, as described in the literature (M. Buback et al., Chem. Ing. Tech. 66 (1994), 510). For this purpose, ethylene and the comonomer mixture comprising polyethylene glycol methacrylate methyl ether and methacrylic acid, to which mixture about 1 000 ml·h⁻¹ of an initiator solution consisting of tert-butyl peroxypivalate (0.1 moll-1) dissolved in isododecane had been added, were fed in under the reaction pressure of 1 700 bar.

The peroxide consumption was from about 1 to 15 g/g of ethylene terpolymer wax. The polymerization temperature was 220±5° C. Table 1 summarizes the polymerization conditions and table 2 summarizes the analytical data of the novel ethylene terpolymer waxes obtained.

The content of ethylene, polyethylene glycol methacrylate methyl ether and methacrylic acid in the novel ethylene terpolymer waxes was determined by NMR spectroscopy or by titration (acid number). The acid number of the polymers was determined titrimetrically according to DIN 53402. The KOH consumption corresponds to the methacrylic acid content in the polymer.

TABLE 1
Preparation of the novel ethylene terpolymer waxes

| | | | | Including | | | |
|---|---|---|---|---|---|---|---|
| | Feed | | | [in each | | | |
| | | Comonomers + | Propionaldehyde + | case g · h⁻¹] | | | |
| | Ethylene | toluene | isododecane | | Methacrylic | | Polymer |
| No. | [g · h⁻¹] | [ml · h⁻¹] | [ml · h⁻¹] | PEMM | acid | Toluene | [g · h⁻¹] |
| 1.1 | 12000 | 250 | 670 | 178.0 | 42.4 | 29.6 | 2550 |
| 1.2 | 12000 | 316 | 640 | 225.0 | 53.6 | 37.4 | 2600 |
| 1.3 | 12440 | 400 | 640 | 284.8 | 67.9 | 47.3 | 2700 |
| 1.4 | 12870 | 588 | 600 | 418.7 | 99.8 | 69.5 | 2940 |
| 1.5 | 12700 | 780 | 580 | 555.4 | 132.3 | 92.2 | 3025 |
| 1.6 | 12250 | 1000 | 600 | 712.1 | 169.7 | 118.2 | 3070 |
| 1.7 | 12410 | 1172 | 560 | 834.6 | 198.8 | 138.6 | 3200 |
| 1.8 | 12210 | 1360 | 500 | 968.4 | 230.7 | 160.8 | 3280 |

Abbreviations used: Tl=toluene; PEMM: polyethylene glycol methacrylate methyl ether.

The analytical data of the ethylene terpolymer waxes are shown in table 2.

TABLE 2
Analytical data of the novel ethylene terpolymer waxes

| | Composition | | | | | | |
|---|---|---|---|---|---|---|---|
| | NMR/titrimetrically | | | Acid | | | |
| | Ethylene | | Methacrylic | number | | | |
| | [% by | PEMM [% | acid [% | [mg KOH | Q (23° C.) | ν (120° C.) | Mp. |
| No. | wt.] | by wt.] | by wt.] | g⁻¹] | [g cm⁻³] | [mm² s⁻¹] | [° C.] |
| 1.1 | 94.0 | 4.7 | 1.3 | 8.7 | 0.9455 | 1170 | 108.1 |
| 1.2 | 92.5 | 6.0 | 1.5 | 9.6 | 0.9427 | 1280 | 107.5 |
| 1.3 | 91.0 | 7.1 | 1.9 | 12.6 | 0.9469 | 1240 | 106.3 |
| 1.4 | 87.5 | 10.0 | 2.5 | 16.0 | 0.9488 | 1220 | 104.7 |
| 1.5 | 84.0 | 12.8 | 2.9 | 18.6 | 0.9507 | 1190 | 103.6 |
| 1.6 | 81.4 | 15.9 | 2.7 | 17.3 | 0.9516 | 1280 | 105.7 |
| 1.7 | 77.4 | 18.2 | 4.4 | 28.9 | 0.9653 | 1100 | 100.9 |
| 1.8 | 74.7 | 20.9 | 4.4 | 28.4 | 0.9665 | 1210 | 101.9 |

The melt viscosity was determined with the aid of DSC according to DIN 51562 and the melting points with the aid of DSC according to DIN 51007.

2. Preparation of a Novel Dispersion

933 g of water were initially taken in a 2 liter stirred pot having an anchor stirrer and reflux condenser and were preheated to 90° C. 400 g of the novel ethylene terpolymer wax from example 1.8 were added in portions in the course of 30 minutes and the mixture was refluxed. 22.72 g of 50% by weight aqueous KOH were then added with vigorous stirring. Finally, a further 267 g of water were added and the resulting dispersion was cooled to room temperature. The pH of the dispersion obtained was 11, the solids content was 24.3% by weight and the mean particle size was 180-190 nm, determined according to ISO 13321 using an Autosizer IIC (from Malvern) with the following parameters:

| | |
|---|---|
| Measuring temperature: | 23.0° C. |
| Measuring time: | 200 seconds (10 cycles of 20 s each) |
| Scattering angle: | 90° |
| Laser wavelength: | 633 nm (HeNe) |

3. Preparation of Novel Quaterpolymer Waxes

Ethylene, polyethylene glycol methacrylate methyl ether (R¹═R³═CH₃; R²═H, n=21), acrylic acid (R⁴═H) as a 20% by weight solution in isododecane and methacrylic acid (R⁴═CH₃) were polymerized with addition of toluene as a solvent and propionaldehyde as a regulator in a high-pressure autoclave, as described in the literature (M. Buback et al., Chem. Ing. Tech. 66 (1994), 510). For this purpose, ethylene and the comonomer mixture comprising methacrylic acid and polyethylene glycol methacrylate methyl ether, dissolved in toluene, and methacrylic acid, dissolved in isododecane, were metered. Furthermore, about 1 000 ml·h⁻¹ of an initiator solution consisting of tert-butyl peroxypivalate (from 0.02 to 0.2 mol·l⁻¹), dissolved in isododecane, were fed in under the reaction pressure of 1 700 bar. The polymerization temperature was 220±5° C. Table 3 lists the polymerization conditions and table 4 lists the analytical data of the novel ethylene quaterpolymer waxes obtained.

The peroxide consumption was from about 1 to 15 g/g of quaterpolymer wax. The content of ethylene, acrylic acid, polyethylene glycol methacrylate methyl ether and methacrylic acid in the novel ethylene quaterpolymer waxes was determined by NMR spectroscopy or by titration (acid number). The acid number of the polymers was determined titrimetrically according to DIN 53402. The KOH consumption corresponds to the content of acrylic acid and methacrylic acid in the polymer.

TABLE 3
Preparation of the novel ethylene quaterpolymer waxes

| | Feed | | | | Including | | | | |
|---|---|---|---|---|---|---|---|---|---|
| | | PEMM + | Acrylic | | [in each case | | | | |
| | | MAS + | acid in | | g · h⁻¹] | | | | |
| | Ethylene | toluene | ID [ml · | Propionaldehyde | | | | Acrylic | Polymer |
| No. | [g · h⁻¹] | [ml · h⁻¹] | h⁻¹] | [ml · h⁻¹] | PEMM | MAA | Toluene | acid | [g · h⁻¹] |
| 3.1 | 13000 | 1048 | 760 | 330 | 700 | 190 | 158 | 152 | 3300 |
| 3.2 | 13000 | 1100 | 1370 | 290 | 735 | 199 | 166 | 274 | 3400 |
| 3.3 | 13000 | 1112 | 2050 | 350 | 743 | 202 | 168 | 410 | 4000 |
| 3.4 | 13000 | 2172 | 720 | 200 | 1451 | 394 | 328 | 144 | 5000 |
| 3.5 | 13000 | 2160 | 1440 | 250 | 1443 | 391 | 326 | 288 | 4100 |
| 3.6 | 13000 | 2160 | 1960 | 220 | 1443 | 391 | 326 | 392 | 5200 |
| 3.7 | 13000 | 3272 | 860 | 0 | 2185 | 593 | 494 | 172 | 6100 |
| 3.8 | 13000 | 3268 | 1300 | 0 | 2183 | 592 | 493 | 260 | 5600 |
| 3.9 | 13000 | 3260 | 1830 | 0 | 2177 | 591 | 492 | 366 | 5800 |

Abbreviations used: PEMM: polyethylene glycol methacrylate methyl ether, MAA: methacrylic acid, ID: isododecane.

TABLE 4
Analytical data of the novel ethylene quaterpolymer waxes

| | Composition | | | | | | |
|---|---|---|---|---|---|---|---|
| | NMR/titrimetrically | | | Acid | | | |
| | Ethylene | | MAA + acrylic | number | Q | | |
| | [% by | PEMM [% | acid [% by | [mg KOH | (23° C.) | ν (120° C.) | Mp. |
| No. | wt.] | by wt.] | wt.] | g⁻¹] | [g cm⁻³] | [mm² s⁻¹] | [° C.] |
| 3.1 | 78.4 | 14.94 | 6.65 | 47 | 0.964 | 1250 | 98 |
| 3.2 | 76.5 | 14.59 | 8.88 | 63 | 0.964 | 1250 | 93.6 |
| 3.3 | 75.1 | 14.42 | 10.44 | 74 | 0.964 | 1050 | 91.3 |
| 3.4 | 68.7 | 23.80 | 7.51 | 53 | 0.981 | 920 | 92.1 |
| 3.5 | 67.5 | 23.45 | 9.06 | 64 | 0.972 | 830 | 91.5 |
| 3.6 | 66.1 | 22.90 | 11.02 | 78 | 0.983 | 1030 | 80-90 |
| 3.7 | 60.6 | 30.53 | 8.91 | 63 | 0.990 | 1120 | 70-90 |
| 3.8 | 63.4 | 26.98 | 9.58 | 68 | 0.987 | 1120 | 65-90 |
| 3.9 | 62.8 | 26.74 | 10.42 | 74 | 0.983 | 660 | 65-85 |

1-5. (canceled)

6. A process for the preparation of an ethylene terpolymer waxes, wherein said ethylene terpolymer wax comprises, as monomer building blocks,
from 35 to 95% by weight of ethylene,
from 0.1 to 40% by weight of at least one ester of the formula I 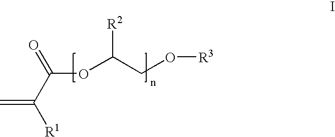
where R¹ is selected from hydrogen. C₁-C₁₀-alkyl, C₃-C₁₂-cycloalkyl and C₆-C₁₄-aryl
R² are identical or different and are selected from hydrogen and C₁-C₁₀alkyl
R³ is selected from C₁-C₁₀-alkyl, C₃-C₁₂-cycloalkyl and C₆-C₁₁-aryl and
n is an integer from 2 to 100,
and from 0.1 to 25% by weight of at least one carboxylic acid of the formula II 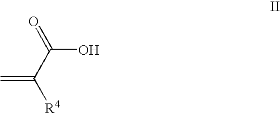
where R⁴ is selected from hydrogen, C₁-C₁₀-alkyl, C₃-C₁₂-cycloalkyl and C₆-C₁₄, wherein in said process, ethylene, at least one ester of the formula I and at least one carboxylic acid of the formula II are polymerized with one another at from 500 to 4000 bar and from 170 to 300° C.

7. An aqueous dispersion comprising one or more ethylene terpolymer waxes as defined in claim 6.

8. (canceled)

9. A floor care composition comprising an aqueous dispersion as claimed in claim 7.

10. (canceled)

11. A leather assistant comprising an ethylene terpolymer wax as defined in claim 6.

12. (canceled)

13. A construction chemical comprising an ethylene terpolymer wax as defined in claim 6.

14. A process for dispersing hydrophobic substances in aqueous media, said process comprising adding the ethylene terpolymer wax defined in claim 6 to the aqueous media.
